(19) United States
(12) Patent Application Publication
(10) Pub. No.: US 2007/0061823 A1
(43) Pub. Date: Mar. 15, 2007

(54) OPTICAL DISC DRIVE

(76) Inventors: Wen-Hong Wang, Taiepi City (TW); Cheng-Hua Chen, Taiepi City (TW); Yu-Feng Chien, Taiepi City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/306,448

(22) Filed: Dec. 28, 2005

(30) Foreign Application Priority Data
Sep. 15, 2005 (TW) 94131799

(51) Int. Cl. G11B 33/02

(52) U.S. Cl. 720/647

(57) ABSTRACT

An optical disc drive for reading data stored in an optical disc is provided. The optical disc drive includes a housing, a front panel, a crashworthy portion and a reading module. The housing has a first opening and the front panel is disposed across the first opening. The front panel has a second opening suitable for taking the optical disc into the housing. The reading module is disposed inside the housing for reading stored data from the optical disc. The crashworthy portion is disposed on the inner wall of the front panel and located in an area above the second opening. The surface of the crashworthy portion that faces the interior of the optical disc drive is an inclined surface.

### CROSS-REFERENCE TO RELATED APPLICATION

This application claims the priority benefit of Taiwan application serial no. 94131799, filed on Sep. 15, 2005. All disclosure of the Taiwan application is incorporated herein by reference.

### BACKGROUND OF THE INVENTION

1. Field of the Invention

The present invention relates to an optical disc drive. More particularly, the present invention relates to an optical disc drive having a contraption for preventing the optical disc fragments hitting.

2. Description of the Related Art

Optical discs become popular because they are inexpensive and portable. Moreover, an optical disc can store large amount of data and the data are not easy to be damaged as the storage is easy, convenient and lasting. Consequently, optical discs have gradually replaced the conventional magnetic storage medium to become an indispensable optical storage medium in our daily life. Because of the widespread application of optical discs, an optical disc player for reading out the data from an optical disc has also become a commonly used electronic product in our everyday life.

FIG. 1A is a perspective view of a conventional optical disc drive. FIG. 1B is a perspective view of the front panel of the optical disc drive shown in FIG. 1A. FIG. 2 is a local cross-sectional view of the optical disc drive shown in FIG. 1A. As shown in FIGS. 1A, 1B and 2, the housing 110 of a conventional optical disc drive 100 has a first opening 112 and a front panel 120 is disposed across the first opening 112. In addition, the front panel 120 has a second opening 122, and a sliding tray 130 for carrying an optical disc can be ejected from the housing 110 via the second opening 122 so that the user can insert an optical disc. Furthermore, the front end of the sliding tray 130 has a cover panel 140 for covering the second opening 122.

In general, the reading module (not shown) inside the housing 110 will spin the optical disc at a very high speed when reading data. If the optical disc has a crack, the spinning may tear up the optical disc into several fragments. These fragments may fly off at a tangent to the spinning direction and smash against the interior walls of the optical disc drive 100. Because the front panel 120 is fastened to the two side plates of the housing 110 through the latching hooks 124, the impact force F due to the impact of a large fragment on the inner wall of the front panel 120 in an area A above the second opening 122 can easily lead to the deformation of the front panel 120. As a result, the latching hooks 124 can no longer restrain the front panel 120 to the housing 110 so that the front panel 120 together with the optical disc fragments may fly out and hurt someone. In addition, the cover panel 140 is mounted to the sliding tray 130 through the latching hooks 142. When the front panel 120 is bent and deformed, the latching hooks 142 of the cover panel 140 may also break so that the cover panel 140 may fly off together with the front panel 120.

### SUMMARY OF THE INVENTION

Accordingly, at least one objective of the present invention is to provide an optical disc drive capable of preventing the front panel of the optical disc drive from thrusting out when impacted by an optical disc fragment.

To achieve these and other advantages and in accordance with the purpose of the invention, as embodied and broadly described herein, the invention provides an optical disc drive for reading data stored inside an optical disc. The optical disc drive includes a housing, a front panel, a crashworthy portion and a reading module. The housing has a first opening and the front panel is disposed across the first opening. The front panel has a second opening for taking the optical disc into the housing. The reading module is disposed inside the housing for reading stored data from the optical disc. The crashworthy portion is disposed on the inner wall of the front panel and located in an area above the second opening. The surface of the crashworthy portion that faces the interior of the optical disc drive is an inclined surface.

In the aforesaid optical disc drive, the crashworthy portion and the front panel are formed together as an integrated unit, for example. Furthermore, the crashworthy portion includes a plurality of spines, for example.

In the aforesaid optical disc drive, the crashworthy portion includes at least an inclined block, for example.

In the aforesaid optical disc drive, the crashworthy portion is distributed over the entire area above the second opening, for example.

In the aforesaid optical disc drive, the included angle between the inclined surface of the crashworthy portion and the front panel is θ where 30°≦θ≦60°, for example.

In the aforesaid optical disc drive, the included angle between the inclined surface of the crashworthy portion and the front panel is θ where θ=30°, for example.

The aforesaid optical disc drive further includes a sliding tray for carrying an optical disc, for example. The sliding tray is disposed inside the housing for ejecting from the housing via the second opening.

The aforesaid optical disc drive further includes a cover panel disposed at the front end of the sliding tray for covering the second opening, for example.

In the optical disc drive of the present invention, the surface of the crashworthy portion facing the interior of the optical disc drive is an inclined surface. Thus, when optical disc fragments hit the crashworthy portion, the inclined surface can reduce the impact force on the front panel in the forward direction. Ultimately, the chance of the front panel flying out after receiving an impact from the optical disc fragments is significantly reduced.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a perspective view of a conventional optical disc drive.

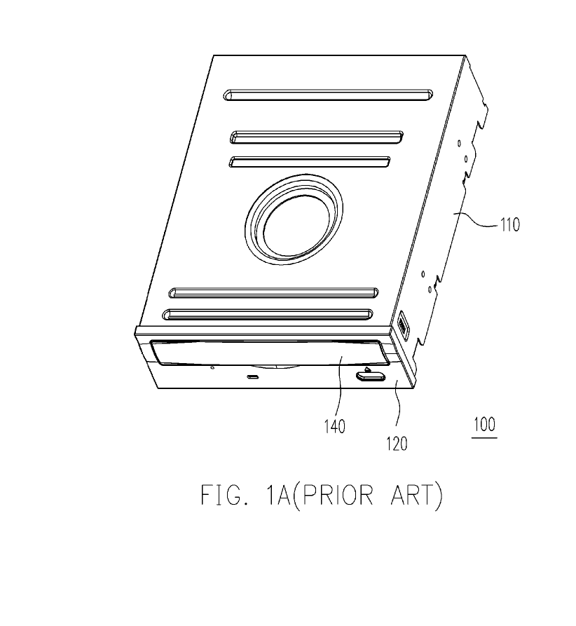

FIG. 1B is a perspective view of the front panel of the optical disc drive shown in FIG. 1A.

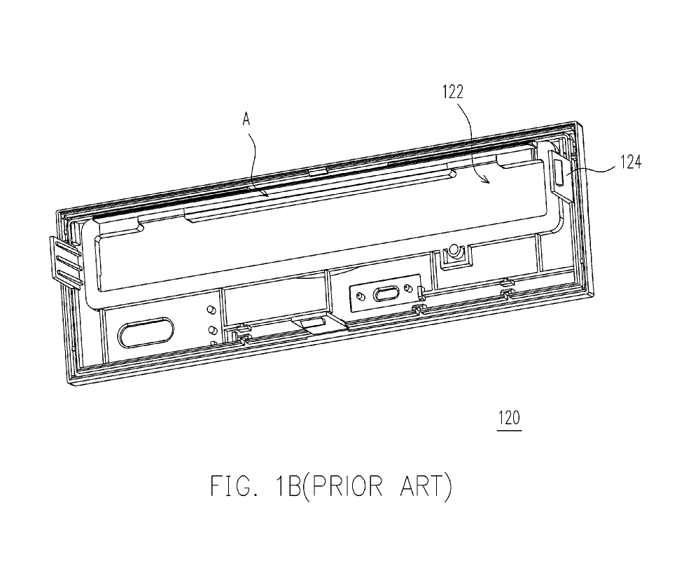

FIG. 2 is a local cross-sectional view of the optical disc drive shown in FIG. 1A.

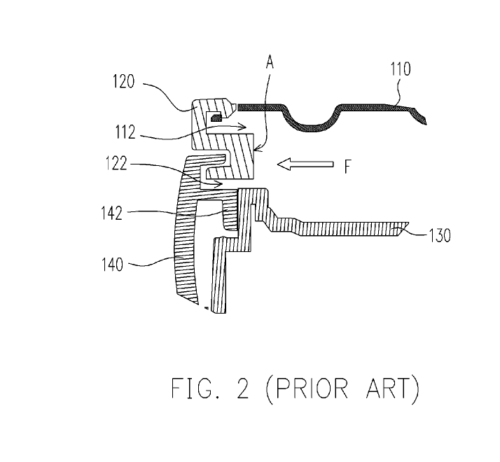

FIG. 3A is a perspective view of an optical disc drive according to one embodiment of the present invention.

FIG. 3B is an explosion view showing various components of the optical disc drive shown in FIG. 3A.

FIG. 3C is a perspective view of the crashworthy portion of the front panel shown in FIG. 3B.

FIG. 4 is a local cross-sectional view of the optical disc drive shown in FIG. 3A.

FIG. 5 is a perspective view of the front panel and the crashworthy portion of an optical disc drive according to another embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

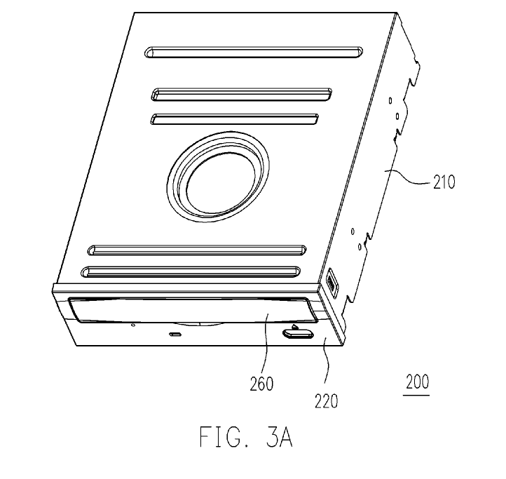

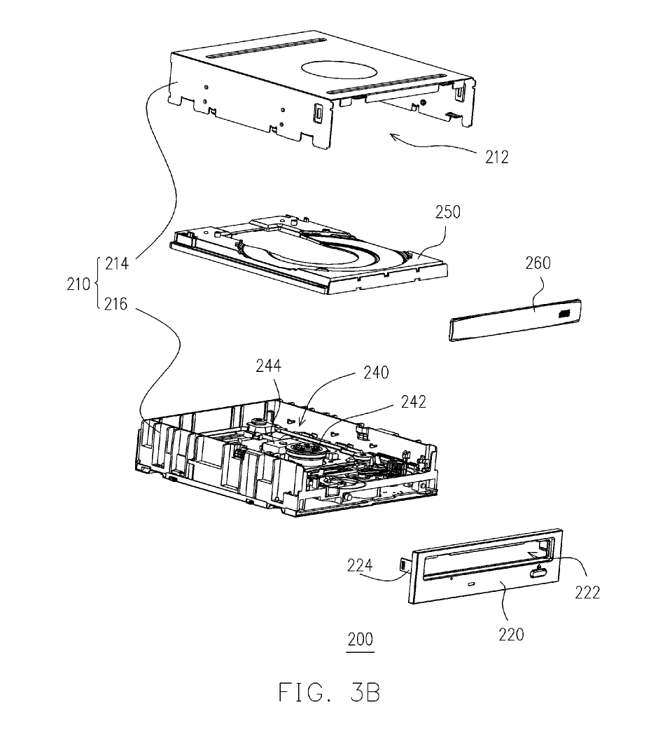

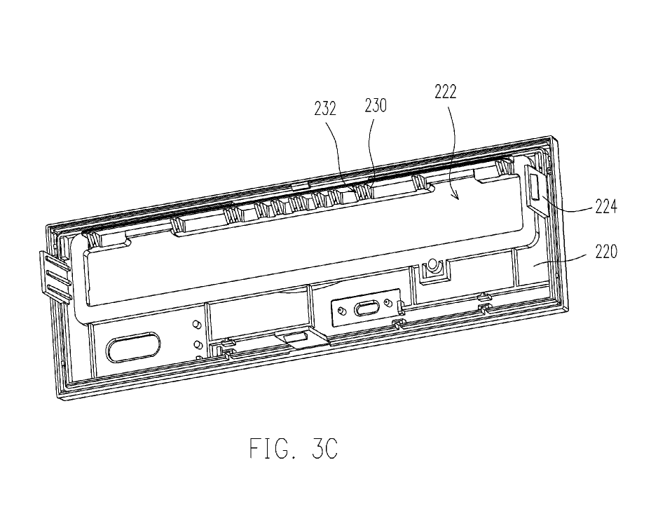

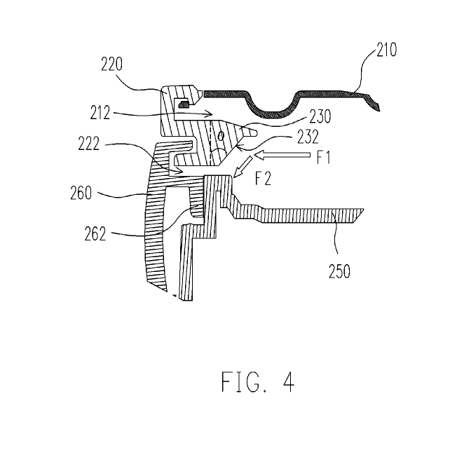

FIG. 3A is a perspective view of an optical disc drive according to one embodiment of the present invention. FIG. 3B is an explosion view showing various components of the optical disc drive shown in FIG. 3A. FIG. 3C is a perspective view of the crashworthy portion of the front panel shown in FIG. 3B. FIG. 4 is a local cross-sectional view of the optical disc drive shown in FIG. 3A. As shown in FIGS. 3A, 3B, 3C and 4, the optical disc drive 200 in the present embodiment is designed to read the data stored in an optical disc. The optical disc drive 200 comprises a housing 210, a front panel 220, a crashworthy portion 230 and a reading module 240. The housing 210 has a first opening 212 and the front panel 220 is disposed across the first opening 212. The front panel 220 has a second opening 222 suitable for taking an optical disc into the housing 210. The reading module 240 is disposed inside the housing 210 for reading stored data from the optical disc. The crashworthy portion 230 is disposed on the inner wall of the front panel 220 and located in an area above the second opening 222. The surface of the crashworthy portion 230 that faces the interior of the optical disc drive 200 is an inclined surface 232.

In the aforementioned optical disc drive 200, the housing 210 includes an upper housing 214 and a lower housing 216, for example. Furthermore, the front panel 220 is fastened to the housing 210 through a latching hook 224, for example. The optical disc drive 200 further includes a sliding tray 250 disposed inside the housing 210, for example. The sliding tray 250 for carrying an optical disc can be ejected from the housing 210 via the second opening 222 so that a user is able to place an optical disc on the tray 250. Typically, the front end of the sliding tray 250 also has a cover panel 260 for covering the second opening 222. The cover panel 260 is fastened to the sliding tray 250 through a latching hook 262, for example. In addition, the reading module 240 comprises a main shaft motor 242 and an optical pick-up head 244, for example. When the optical disc has entered the housing 210 along with the sliding tray 250, the main shaft motor 242 will support and spin the optical disc and the optical pick-up head 244 will read the data stored in the optical disc.

In general, the main shaft motor 242 will spin the optical disc in a very high speed when the optical disc drive 200 is reading data from the optical disc. If the optical disc has a crack, the rapid spinning may disintegrate the optical disc into several fragments. These fragments may fly off at tangent direction of the spinning and strike the interior of the optical disc drive 200. Because the front panel 220 is fastened to the housing 210 through the latching hook 224, the substantial impact force imparted by the fragments on the front panel 220 may easily lead to some bending deformation of the front panel 220. As a result, the latching hook 224 may not be able to restrain the front panel 220 inside the positioning groove of the housing 210. Consequently, the front panel 220 together with the broken optical disc fragments may fly out hurting someone close to the optical disc drive.

In the present embodiment, one way of preventing the front panel 220 and broken optical disc fragments from hurting someone is to set up a crashworthy portion 230 on the inner wall of the front panel 220. The crashworthy portion 230 is disposed in an area above the second opening 222 to reduce the impact force when a broken optical disc fragment hits the front panel 220. More specifically, the inner surface 232 facing the interior of the optical disc drive 200 of the crashworthy portion 230 is an inclined surface. The inclined surface can deflect the broken optical disc fragments to hit on the sliding tray 250 and disperse the forward impact force F1 caused by the fragments hitting the front panel 220 when the fragments crash onto the crashworthy portion 230. Hence, a portion of the impact force F2 is diverted to the sliding tray 250. With this additional setup, the chance of a significant bending and deformation of the front panel 220 due to an excessive impact force causing the front panel 220 to fly off with some optical disc fragments and hurt someone is minimized. Furthermore, with an improvement in the degree of bending and deformation of the front panel 220 resulting from an impact by optical disc fragments, the latching hook 262 restraining the cover panel 260 will not be so readily broken and fly off to hurt someone.

In the optical disc drive 200 of the present invention, the crashworthy portion 230 and the front panel 220 can be fabricated together as an integrated unit. Furthermore, the crashworthy portion in the present embodiment may include a plurality of reinforcement spines, for example. In addition, the crashworthy portion 230 is distributed over the entire area above the second opening 222, for example. The included angle θ between the inclined surface of the crashworthy portion 230 and the front panel 220 is within the range 30°≦θ≦60°, preferably θ=30°.

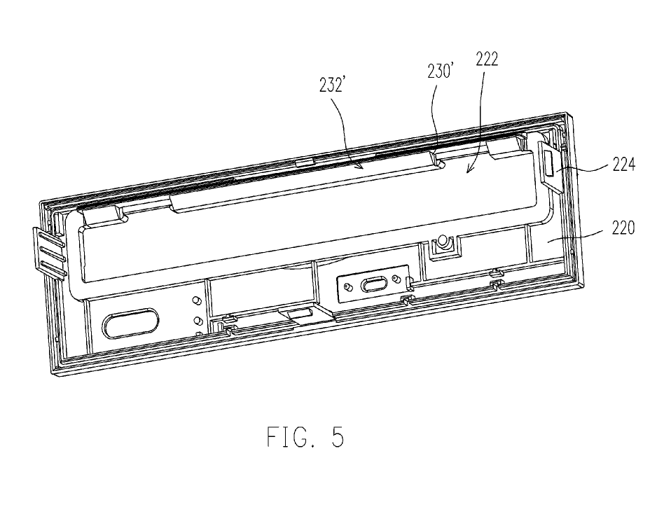

FIG. 5 is a perspective view of the front panel and the crashworthy portion of an optical disc drive according to another embodiment of the present invention. The front panel and the crashworthy portion in FIG. 5 are very similar to the one in FIG. 3C. The difference is that the crashworthy portion 230 in FIG. 3 has a plurality of spines and the crashworthy portion 230 and the front panel 220 are formed together as an integrated unit. In FIG. 5, the crashworthy portion 230′ has at least an inclined block attached to the inner wall of the front panel 220. In other words, the crashworthy portion in the present invention is not limited to the fabrication of spines with inclined surface and the crashworthy portion and the front panel 220 is not necessarily formed together as an integrated unit.

In summary, the optical disc drive of the present invention has a crashworthy portion whose surface that faces the interior of the optical disc drive is an inclined surface. Thus, when optical disc fragments hit the crashworthy portion, the inclined surface can reduce the force of impact on the front panel in the forward direction and hence reduce the degree of bending and deformation of the front panel by the optical disc fragments. Ultimately, the chance of the front panel flying out after receiving an impact from the optical disc fragments is significantly reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical disc drive for reading stored data within an optical disc, comprising:
a housing with a first opening;
a front panel disposed across the first opening, wherein the front panel has a second opening and the optical disc is suitable for retracting into the interior of the housing via the second opening;
a crashworthy portion disposed on the inner wall of the front panel and located above the second opening, wherein the surface of the crashworthy portion facing the interior side of the optical disc drive is an inclined surface; and
a reading module disposed inside the housing for reading the data stored inside the optical disc.

2. The optical disc drive of claim 1, wherein the crashworthy portion and the front panel are formed together as an integrated unit.

3. The optical disc drive of claim 2, wherein the crashworthy portion includes a plurality of spines.

4. The optical disc drive of claim 1, wherein the crashworthy portion includes at least an inclined block.

5. The optical disc drive of claim 1, wherein the crashworthy portion is distributed over the entire area above the second opening.

6. The optical disc drive of claim 1, wherein the included angle θ between the inclined surface of the crashworthy portion and the front panel is between 30° to 60°, that is, 30°≦θ≦60°.

7. The optical disc drive of claim 1, wherein the included angle θ between the inclined surface of the crashworthy portion and the front panel is 30°, that is, θ=30°.

8. The optical disc drive of claim 1, wherein the optical disc drive further includes a sliding tray disposed inside the housing for carrying an optical disc and suitable for ejecting from the housing via the second opening.

9. The optical disc drive of claim 8, wherein the optical disc drive further includes a cover panel disposed on the front end of the sliding tray for covering the second opening.
